(19) United States
(12) Patent Application Publication
(10) Pub. No.: US 2023/0149931 A1
(43) Pub. Date: May 18, 2023

(54) BIOASSAY SUBSTRATE HAVING FIDUCIAL DOMAINS AND METHODS OF MANUFACTURE THEREOF

(71) Applicants: NanoString Technologies, Inc., Seattle, WA (US); Lam Research Corporation, Fremont, CA (US)

(72) Inventors: Camelia RUSU, Pleasanton, CA (US); Huawen WU, San Jose, CA (US); Joshua Dale BAKER, Los Altos, CA (US); Jeffrey MARKS, Saratoga, CA (US); Wesley C. CHANG, Fremont, CA (US); Dae KIM, Bellevue, WA (US)

(21) Appl. No.: 17/996,887

(22) PCT Filed: Apr. 23, 2021
(86) PCT No.: PCT/US2021/028934

§ 371 Date: Oct. 21, 2022

Related U.S. Application Data
(60) Provisional application No. 63/014,873, filed on Apr. 24, 2020.

(51) Int. Cl. B01L 3/00

(52) U.S. Cl. CPC B01L 3/508; B01L 2200/12; B01L 2300/0636; B01L 2300/0896; B01L 2300/168

(57) ABSTRACT

Embodiments of the present disclosure are directed to an array substrate which can be used in nucleic acid sequencing, which includes a plurality of fiducial domains (FDs). The disclosure also includes array substrate manufacturing methods and methods for making FDs on such substrates.

### RELATED APPLICATIONS

This application claims benefit of and priority to U.S. provisional patent application No. 63/014,873, filed Apr. 24, 2020, the entire disclosure of which is herein incorporated by reference.

### BACKGROUND

Currently, in tracking bioassays, fiducial beads are used as markers, where the beads are made from polystyrene and sized approximately 100 nm in diameter. Fluorescent dyes are embedded in the polystyrene matrix which fluoresce when exposed to certain wavelengths of light. Problems in using such beads as markers in bioassays include, for example, inconsistencies in the density of beads, as well as in the reproducibility of the attachment of the beads, from experiment to experiment. Moreover, beads can aggregate while in suspension, which can lead to clogging of the bioassay/flow cell, and the flourochrome contained in the beads can often times photobleach.

### SUMMARY OF THE EMBODIMENTS

In some embodiments, an array substrate (can also be referred to as a layer) which can be used in nucleic acid sequencing, is provided, where the substrate includes a plurality of fiducial domains (FDs). Such embodiments can include one and/or another of (and in some embodiments, a plurality of, and in some embodiments, a majority of, and in still other embodiments, substantially all, or all of) the following features, functions, structure, steps, processes, objectives, advantages, and clarifications, yielding yet further embodiments of the present disclosure:
the substrate is selected from the group consisting of silicon and glass;
at least a portion of the substrate comprises silicon, glass, or a combination thereof;
a density of the plurality of FDs on the substrate is between 10 and 10,000 per mm² (and in some embodiments between any of: 100-1000 per mm², 200-2000 per mm², 300-3000 per mm², 400-4000 per mm², 500-5000 per mm², 600-6000 per mm², 700-7000 per mm², 800-8000 per mm², 900-9000 per mm², 1000-10,000 per mm², 1000-2000 per mm², 1000-3000 per mm², 2000-4000 per mm², 3000-5000 per mm², 4000-6000 per mm², 5000-7000 per mm², 6000-8000 per mm², 7000-9000 per mm², and 9000-10,000 per mm²) and ranges therebetween any of the preceding;
a density of the plurality of FDs on the substrate is between 10 and 1000 per mm² (and in some embodiments, between any of: 10-100 per mm², 10-200 per mm², 10-300 per mm², 10-400 per mm², 10-500 per mm², 10-600 per mm², 10-700 per mm², 10-800 per mm², 10-900 per mm², 100-200 per mm², 100-300 per mm², 100-400 per mm², 100-500 per mm², 100-600 per mm², 100-700 per mm², 100-800 per mm², 100-900 per mm², 100-1000 per mm², 200-300 per mm², 200-400 per mm², 200-500 per mm², 200-500 per mm², 200-600 per mm², 200-700 per mm², 200-800 per mm², 200-900 per mm², 200-1000 per mm², 300-400 per mm², 300-500 per mm², 300-600 per mm², 300-700 per mm², 300-800 per mm², 300-900 per mm², 300-1000 per mm², 400-500 per mm mm² 400-600 per mm², 400-700 per mm², 400-800 per mm², 400-900 per mm², 400-1000 per mm², 500-600 per mm², 500-700 per mm², 500-800 per mm², 500-900 per mm², 500-1000 per mm², 600-700 per mm², 600-800 per mm², 600-900 per mm², 600-1000 per mm², 700-800 per mm², 700-900 per mm², 700-1000 per mm², 800-900 per mm², 800-1000 per mm², and 900-1000 per mm²) and ranges therebetween of any of the preceding;
the FDs comprise a matrix material which includes at least one dye;
the at least one dye comprises a plurality of dyes;
the matrix material comprises at least one of an oxide and a polymer;
the at least one dye is embedded into the matrix material;
the at least one dye contain fluorochromes (and in some embodiments, the fluorochromes are registerable);
the plurality of FDs are arranged at fixed locations along the substrate;
the plurality of FDs are sized so as to be less than or near a diffraction limit to enable auto-focus;
the FDs are sized to be between 200 and 400 nanometers (and in some embodiments, between any of: 200-250 nm, 200-300 nm, 200-350 nm, 300-325 nm, 300-350 nm, 300-375 nm, and 300-400 nm), and ranges therebetween any of the preceding;
the FDs are sized to be approximately 360 nanometers;
the FDs are configured as specific shapes;
the at least one dye is selected from the group consisting of: Alexa Fluor 488, 532, 594, and 647;
and
a reflective layer, where the reflective layer is (in some embodiments) arranged underneath the oxide or SiN layers, and in some embodiments, the reflective layer comprises aluminum (which, in some embodiments, the layer can be considered a substrate).

In some embodiments, an array substrate manufacturing method for nucleic acid assays is provided and includes providing a substrate having at least one side comprising a Silicon-Ox/Silicon or Silicon-Nx/Silicon material, depositing an omni-fluorescent material (OMF) layer on the at least one side comprising the Silicon-Ox/Nx, depositing a photoresist layer (PRL) on the OMF layer, removing portions of the PRL, removing the exposed portions of OMF, and removing a remainder of the PRL.

Such embodiments can include one and/or another of (and in some embodiments, a plurality of, and in some embodiments, a majority of, and in still other embodiments, substantially all, or all of) the following features, functions, structure, steps, processes, objectives, advantages, and clarifications, yielding yet further embodiments of the present disclosure:
the Silicon-Ox/Silicon or Silicon-Nx/Silicon material includes a thickness of between 100 nm to 800 nm (and in some embodiments, between any of: 100-200 nm, 100-300 nm, 100-400 nm, 100-500 nm, 100-600 nm, 100-700 nm, 200-300 nm, 200-400 nm, 300-400 nm, 300-500 nm, 300-600 nm, 300-700 nm, 300-800 nm, 400-500 nm, 400-600 nm, 400-700 nm, 400-800 nm, 500-600 nm, 500-700 nm, 500-800 nm, 600-700 nm, 600-800 nm, and 700-800 nm), and ranges therebetween any of the proceeding;
the Silicon-Ox/Silicon or Silicon-Nx/Silicon material includes a minimum thickness of 800 nm;
the OMF layer is between approximately 300-400 nm in thickness (and in some embodiments, between any of: 200-500 nm, 200-400 nm, 200-300 nm) and ranges therebetween any of the preceding;
the PRL is approximately 400 nm in thickness (and in some embodiments, between any of: 200-600 nm, 200-300 nm, 200-400 nm, 200-500 nm, 300-400 nm, 300-500 nm, 300-600 nm, 400-500 nm, 400-600 nm, and 500-600 nm), and ranges therebetween of any of the preceding;
patterning the PRL, where, patterning can establish features between 100-500 nm (and in some embodiments, between any of: 100-200 nm, 200-300 nm, 300-400 nm, 400-500 nm, 200-300 nm, 200-400 nm, 200-500 nm, or 300-400 nm) and ranges therebetween of any of the proceeding, and/or features between 1-100 nm (and in some embodiments, between any of: 1-50 nm, 10-50 nm, 25-50 nm, 50-75 nm, and 50-100 nm), and ranges therebetween of any of the preceding;
removing portions of the PRL establishes a pattern in the PRL which exposes corresponding portions of the OMF;
removing the exposed portions of OMF exposes the Silicon-Ox/Silicon or Silicon-Nx/Silicon substrate;
and
removing a remainder of the PRL exposes the OMF domains;

In some embodiments, an array substrate manufacturing method for nucleic acid assays is provided, which includes providing a substrate having at least one side comprising a Silicon-Ox/Silicon substrate or Silicon-Nx/Silicon, depositing an omni-fluorescent material (OMF) layer on the at least one side comprising the Silicon-Ox/Nx, depositing a photoresist layer (PRL) on the OMF layer, removing portions of the PRL to establish a pattern in the PRL, wherein the removed portions expose corresponding portions of the OMF, removing the exposed portions of OMF to expose the Silicon-Ox/Silicon or Silicon-Nx/Silicon substrate, and removing a remainder of the PRL thereby exposing the OMF domains.

Such embodiments can include one and/or another of (and in some embodiments, a plurality of, and in some embodiments, a majority of, and in still other embodiments, substantially all, or all of) the following features, functions, structure, steps, processes, objectives, advantages, and clarifications, yielding yet further embodiments of the present disclosure:
the Silicon-Ox/Silicon or Silicon-Nx/Silicon material includes a thickness of between 100 nm to 800 nm (and in some embodiments, between any of: 100-200 nm, 100-300 nm, 100-400 nm, 100-500 nm, 100-600 nm, 100-700 nm, 200-300 nm, 200-400 nm, 300-400 nm, 300-500 nm, 300-600 nm, 300-700 nm, 300-800 nm, 400-500 nm, 400-600 nm, 400-700 nm, 400-800 nm, 500-600 nm, 500-700 nm, 500-800 nm, 600-700 nm, 600-800 nm, and 700-800 nm), and ranges therebetween any of the proceeding;
the Silicon-Ox/Silicon or Silicon-Nx/Silicon material includes a minimum thickness of 800 nm;
the OMF layer is between approximately 300-400 nm in thickness (and in some embodiments, between any of: 200-500 nm, 200-400 nm, and 200-300 nm) and ranges therebetween any of the preceding;
the PRL is approximately 400 nm in thickness (and in some embodiments, between any of: 200-600 nm, 200-300 nm, 200-400 nm, 200-500 nm, 300-400 nm, 300-500 nm, 300-600 nm, 400-500 nm, 400-600 nm, and 500-600 nm) and ranges therebetween of any of the preceding;
and
patterning the PRL, where, patterning can establish features between 100-500 nm (and in some embodiments, between any of: 100-200 nm, 200-300 nm, 300-400 nm, 400-500 nm, 200-300 nm, 200-400 nm, 200-500 nm, and 300-400 nm), and ranges therebetween of any of the proceeding, and/or features between 1-100 nm (and in some embodiments, between any of: 1-50 nm, 10-50 nm, 25-50 nm, 50-75 nm, and 50-100 nm) and ranges therebetween of any of the preceding.

In some embodiments, an array substrate manufacturing method for nucleic acid assays is provided and comprises providing a substrate having at least one side comprising Silicon-Ox/Silicon, depositing an omni-fluorescent material (OMF) layer on the at least one side comprising the Silicon-Nx, depositing a photoresist layer (PRL) on the OMF layer, removing portions of the PRL, and removing exposed portions of OMF.

Such embodiments can include one and/or another of (and in some embodiments, a plurality of, and in some embodiments, a majority of, and in still other embodiments, substantially all, or all of) the following features, functions, structure, steps, processes, objectives, advantages, and clarifications, yielding yet further embodiments of the present disclosure:
removing portions of the PRL establishes a pattern in the PRL;
the removed portions of the PRL exposes corresponding portions of the OMF;
removing the exposed portions of OMF exposes the Silicon-Nx/Silicon material;
performing blocking chemistry;
performing blocking chemistry which can include at least one of functionalization of the surface with APTMS (3-aminopropyl-trimethoxy-silane solution) to yield primary amines and treatment of the primary amine surface with sulfo-NHS acetate;
etching of the OMF, where etching can comprise anisotropic etching;
the Silicon-Ox/Silicon material includes a thickness of between 100 nm to 800 nm (and in some embodiments, between any of: 100-200 nm, 100-300 nm, 100-400 nm, 100-500 nm, 100-600 nm, 100-700 nm, 200-300 nm, 200-400 nm, 300-400 nm, 300-500 nm, 300-600 nm, 300-700 nm, 300-800 nm, 400-500 nm, 400-600 nm, 400-700 nm, 400-800 nm, 500-600 nm, 500-700 nm, 500-800 nm, 600-700 nm, 600-800 nm, and 700-800 nm), and ranges therebetween any of the proceeding;
the Silicon-Ox/Silicon material includes a minimum thickness of 800 nm;
the OMF layer is between approximately 300-400 nm in thickness (and in some embodiments, between any of: 200-500 nm, 200-400 nm, and 200-300 nm) and ranges therebetween any of the preceding;
the PRL is approximately 400 nm in thickness (and in some embodiments, between any of: 200-600 nm, 200-300 nm, 200-400 nm, 200-500 nm, 300-400 nm, 300-500 nm, 300-600 nm, 400-500 nm, 400-600 nm, and 500-600 nm, and ranges therebetween of any of the preceding;
and
patterning the PRL, where, patterning can establish features between 100-500 nm (and in some embodiments, between any of: 100-200 nm, 200-300 nm, 300-400 nm, 400-500 nm, 200-300 nm, 200-400 nm, 200-500 nm, and 300-400 nm) and ranges therebetween of any of the proceeding, and/or features between 1-100 nm (and in some embodiments, between any of: 1-50 nm, 10-50 nm, 25-50 nm, 50-75 nm, and 50-100 nm), and ranges therebetween of any of the preceding;
removing a remainder of the PRL;
and
removing the remainder of the PRL exposes the OMF domains.

In some embodiments, an array substrate manufacturing method for nucleic acid assays is provided and includes providing a substrate having at least one side comprising Silicon-Ox/Silicon, depositing an omni-fluorescent material (OMF) layer on the at least one side comprising the Silicon-Nx, depositing a photoresist layer (PRL) on the OMF layer, removing pattern portions of the PRL to establish a pattern in the PRL, wherein the removed portions expose corresponding portions of the OMF, removing the exposed portions of OMF to expose the Silicon-Nx/Silicon substrate, performing blocking chemistry, anisotropic etching of the OMF, and removing a remainder of the PRL thereby exposing the OMF domains.

In some embodiments, a fiducial marker substrate preparation method is provided and includes dissolving a first dye in a spin-on-glass material (SOG) to a desired concentration to produce an omni-fluorescent material (OMF), spin-coating the OMF on a substrate at an RPM of between a predetermined amount for a predetermined amount of time at a first temperature, and curing the substrate at a second temperature for curing period.

Such embodiments can include one and/or another of (and in some embodiments, a plurality of, and in some embodiments, a majority of, and in still other embodiments, substantially all, or all of) the following features, functions, structure, steps, processes, objectives, advantages, and clarifications, yielding yet further embodiments of the present disclosure:
the RPMs comprise a range of between about 100 and about 4000, and ranges therebetween;
the RPMs are between about 100 and about 2000, and ranges therebetween;
the RPMs are between about 100 and about 1000, and ranges therebetween;
the RPMs are between about 100 and 500, and ranges therebetween;
the predetermined period of time is between 1 and 300 seconds, and ranges therebetween;
the predetermined period of time is between 1 and 200 seconds, and range therebetween;
the predetermined period of time is between 1 and 100 seconds, and ranges therebetween;
the predetermined period of time is between 100 and 300 seconds, and ranges therebetween;
the predetermined period of time is between 100 and 200 seconds, and ranges therebetween;
the predetermined period of time is between 30 and 150 seconds, and ranges therebetween;
the first temperature is room temperature;
the second temperature is approximately 80 deg. C., and/or the curing period is approximately 2 hours;
and
repeating one or more of any of the preceding steps for each of a plurality of different dyes at the desired concentration.

These and other embodiments, advantages, and objects of the present disclosure will become even more evident with reference to the following detailed description, as well as the figures referred to therein, a brief description of which follows.

### BRIEF DESCRIPTION OF THE DRAWINGS

FIG. 1 illustrates chemistry/process for depositing an omni-fluorescent material according to some embodiments of the disclosure;

FIGS. 2A-2B illustrates a comparison of FDs (FIG. 2B), according to some embodiments of the disclosure, compared to bead structures (FIG. 2A);

FIG. 3 is a graph illustrating photobleaching for structures shown in FIGS. 2A-B;

FIG. 4 illustrates an example process for creating FDs using Oxide/Si wafers as substrates, according to some embodiments of the present disclosure;

FIG. 5 illustrates an example of a process for creating fiducial domains on a SiN/Si wafer, according to some embodiments;

FIG. 6A is a diagram of the FDs/OMF of the process of FIG. 5;

FIG. 6B is a scanning Electron Microscopy (SEM) image of the diagram of FIG. 6A;

FIG. 7 illustrates an overview of an example of a process for incorporating both ordered arrays and fiducial domains on a same chip, according to some embodiments;

FIG. 8A illustrates a block diagram of a wafer chip containing both OMF domain structures and an ordered array region, according to some embodiments;

FIG. 8B a Scanning Electron Microscopy (SEM) image of FIG. 8A;

FIG. 9 illustrates an example fiducial pattern according to some embodiments;

FIG. 10 illustrates an example die incorporating fiducial markers, according to some embodiments;

FIG. 11 illustrates examples of blocking chemistry process according to some embodiments;

FIG. 12 illustrates a table for dye concentrations, according to some embodiments;

FIG. 13 illustrates a graph of Fluorescence Intensity versus Dye concentration, according to some embodiments;

FIG. 14 illustrates example thicknesses of an OMF layer as it varies with the spin speed, according to some embodiments; and

FIG. 15 is a graph illustrating the fluorescence intensity of the OMF treated versus not treated, according to some embodiments.

### DETAILED DESCRIPTION

In some embodiments of the present disclosure, fiducial markers, and in some embodiments, fluorescent fiducial markers, are used in a bioassay so as to:
(1) enable registration of each of the four colors and to compensate for chromatic aberrations,
(2) enable registration of images captured at successive time intervals vs a fixed reference, and
(3) and be used as targets for autofocus.

Accordingly, in some embodiments, fluorescent fiducial domains (which can be referred to herein as “fiducial domains”, as well as “FD(s)”) are provided on a substrate which eliminate issues related to the use of fiducial beads (see BACKGROUND, above). In some embodiments, the fiducial domains may be fabricated on substrates (including, for example, silicon, glass substrates, and the like), using, for example, processes similar to semiconductor processing technologies. Preferably, and according to some embodiments, fiducial domains are fixed on the substrate/wafer. In some embodiments, therefore:
(1) density of the FDs can be controlled and/or unchanged from experiment to experiment;
(2) since the FDs are fixed (in some embodiments), there is no agglomeration thereof, and therefore, the clogging of the flow cell is eliminated; and
(3) intensity of an emission signal of the fiducial domain/marker can be controlled by, for example and according to some embodiments, adjusting the concentration of one or more of the fluorochromes (and in some embodiments, each), for example the dyes incorporated therein, into the matrix material of the fiducial domains.

The fiducial domains, in some embodiments, are made of an omni-fluorescent material or OMF. The OMF, in some embodiments, is made of a matrix material and of one or more dyes of interest (or, in some embodiments, a plurality thereof). The matrix material can be, for example, oxide, inorganic or organic polymers, and the like, and its role in some embodiments is to create a matrix that embeds the dye molecules.

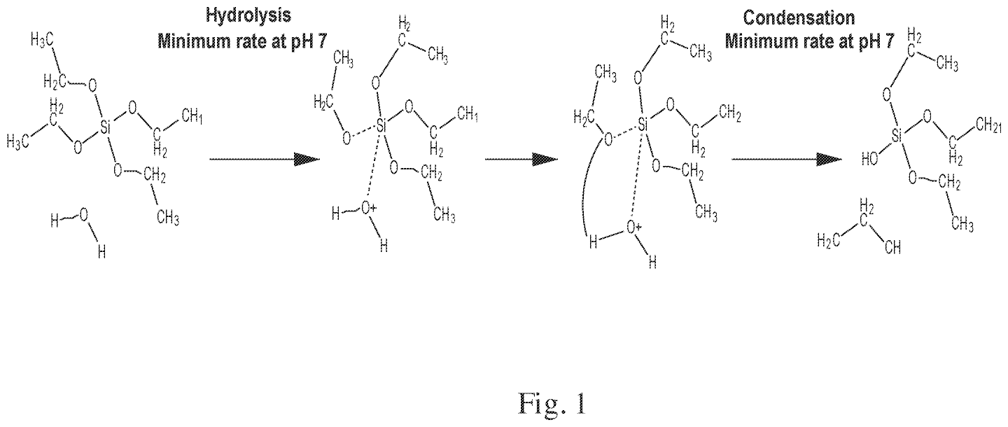

In some embodiments, OMF can be based on Spin-on-Glass (SOG) as the matrix material. A precursor for SOG in such embodiments, is tetraethoxysilane (TEOS). By thermally treating the material, according to some embodiments, the formation of Si—O—Si bonds takes place creating a matrix like material. Such a process is outlined in FIG. 1, in which the SOG precursor comprises TEOS. A condensation process takes place, e.g., water condensation (a)-(b), and alcohol condensation (c)-(d) in the process of curing (i.e., baking) with the formation of Si—O—Si bonds characteristic to glass. In some embodiments, the Si—O—Si inorganic matrix created can incorporate dyes of interest, including, for example, Alexa Fluor 488, 532, 594, and/or 647.

The FDs, in some embodiments, are created on the substrate, and therefore, can have a fixed location enabling the registration of the images versus the reference created by the FDs. The FDs are preferably, in some embodiments, less or near the diffraction limit, approximately 360 nm to enable auto-focus.

The FDs, in some embodiments, may be of various forms or shapes, including, for example, circles and/or cross-hairs, based on the needs of the user.

The substrates on which the fiducial domains are created on, in some embodiments, comprise, for example, oxide or SiN layers over a Si layer. In some embodiments, a reflective layer may be included and arranged underneath the oxide or SiN layers (e.g., an Aluminum layer). In such embodiments which utilize an aluminum layer, signal-to-noise ratio is improved.

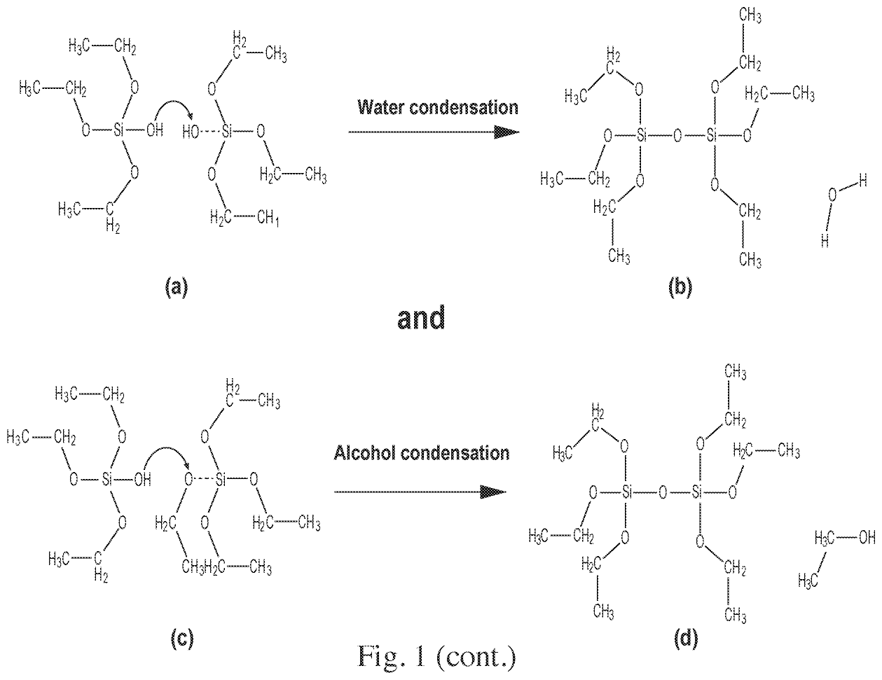

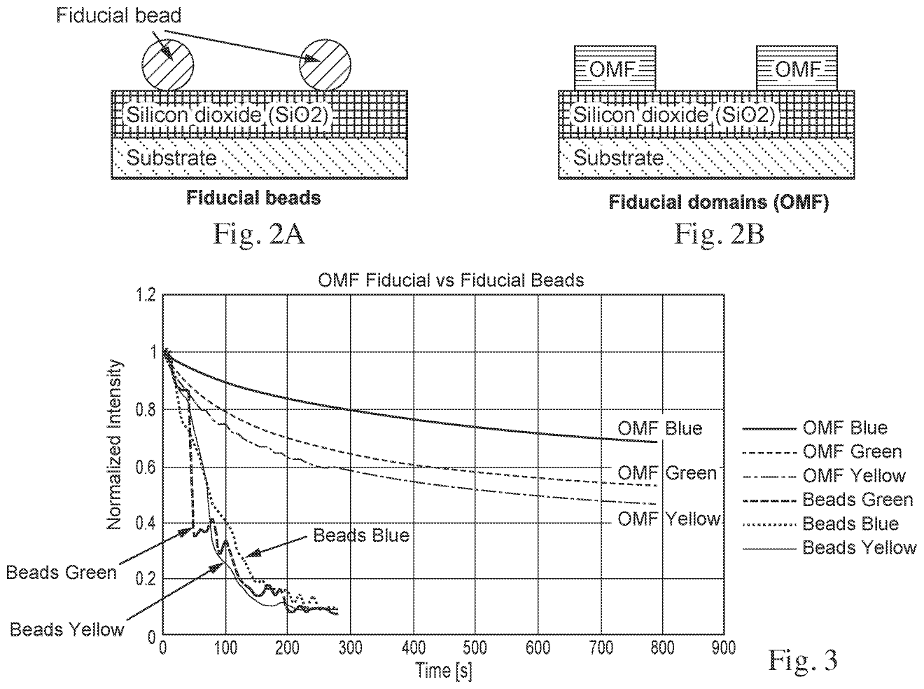

In some embodiments, the photostability of the FDs versus the use of beads is improved (and in some embodiments, significantly improved). Accordingly, a comparison of the light intensity of the OMF to the user of beads for the same exposure time shows that the dyes in OMF are, for example, is 4-6 times brighter than the corresponding dyes in beads. Thus, the practical impact of such an improvement is that, and for example, the FDs/markers, in some embodiments, do not photobleach over an extended period of time (e.g., 800 seconds), as the light intensity is decreased only by 50% (for example). FIG. 2 illustrates a comparison of FDs according to some embodiments, and bead structures: the fiducial beads absorbed on the wafer versus the FDs created on the wafer. To this end, the graph in FIG. 3 illustrates photobleaching for the structures shown in FIG. 2. As shown in the graph, photostability is significantly improved in fiducial domains versus fiducial beads. The information obtained for the graph was obtained via testing done in a buffer solution, on a patterned wafer. During the test, the structure was continuously exposed to light, and the light intensity was acquired every 10 seconds. To this end, the photobleaching rate is defined by the decrease in intensity versus time.

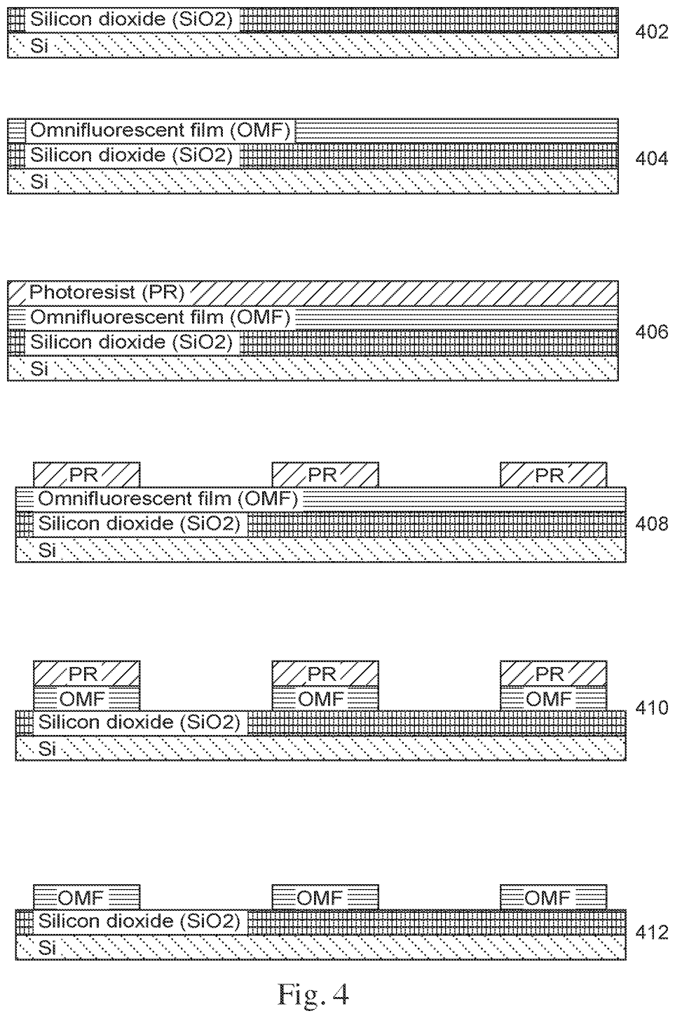

Creating Fiducial Domains Using Oxide/Si wafers as substrates. In some embodiments, the FDs are created via a certain methodology, an overview of an example of such a method is shown in FIG. 4. Accordingly, in a first step 402, an oxide/Si wafer is provided, which, in some embodiments, are wafers which are a minimum of 800 nm oxide (although, in some embodiments, any oxide type can be used, although thermal oxide is a cost-efficient option). Subsequent to the above step, the wafer is coated, in step 404, with an omni-fluorescent film (OMF), which, in some embodiments, are between approximately 300-400 nm in thickness (although in some embodiments, thickness of this layer is not limited this range. The OMF coated wafer is then coated with photoresist (PR) in step 406, which can be around 400 nm in thickness. Following such coating, the PR is patterned with a desired pattern in step 408.

The process then includes, in step 410, opening the OMF material, which can be via (for example) an ICP type etcher: 70 mT, 80 sccm CHF3, 8 sccm O2 at 150 W @13.56 MHz, for an etch rate of ER ˜700 Å/min. A time etched is then performed, so as to fully open the OMF and minimize the etching into the silicon dioxide layer. The PR is then removed in step 412, using, for example, EKC 830™ (DuPont™).

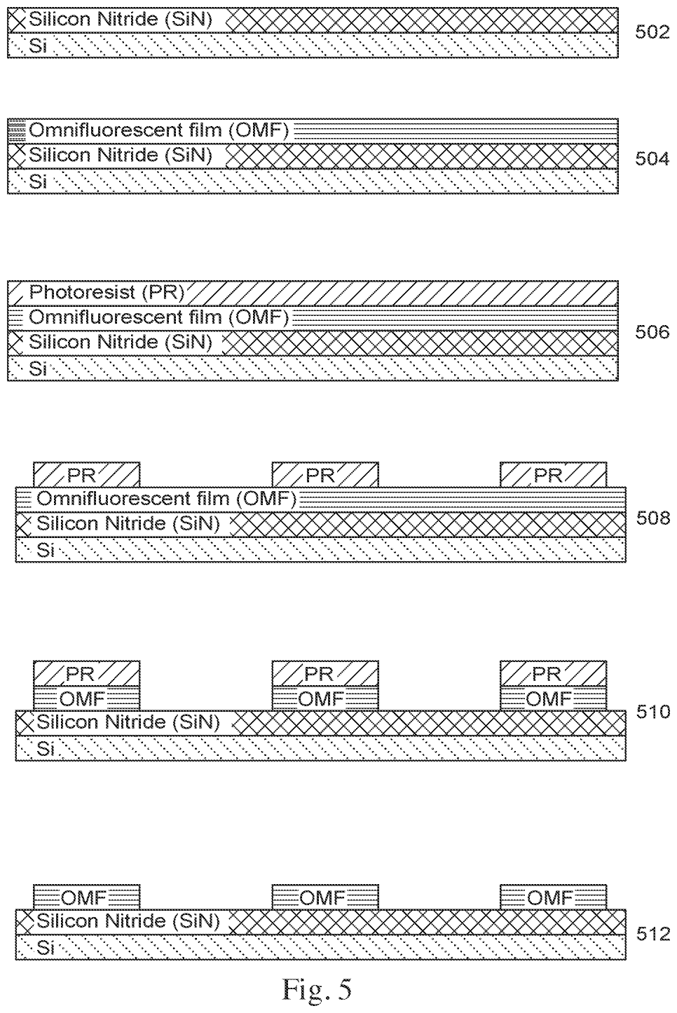

Creating Fiducial Domains Using Silicon Nitride (SiN)/Si wafers as substrates. FIG. 5 outlines an example of a process, according to some embodiments, to create fiducial domains made of an OMF on a SiN/Si wafer. In a first step, an SiNx silicon nitride/Si wafer is provided 502, which can be of a thickness of approximately 100 nm. The wafer is then coated with OMF preferably in step 504, preferably approximately 300-400 nm in thickness. The OMF costed SiN/Si wafer is then coated with photoresist (PR), in step 506, and then the PR is patterned with a desired pattern in step 508.

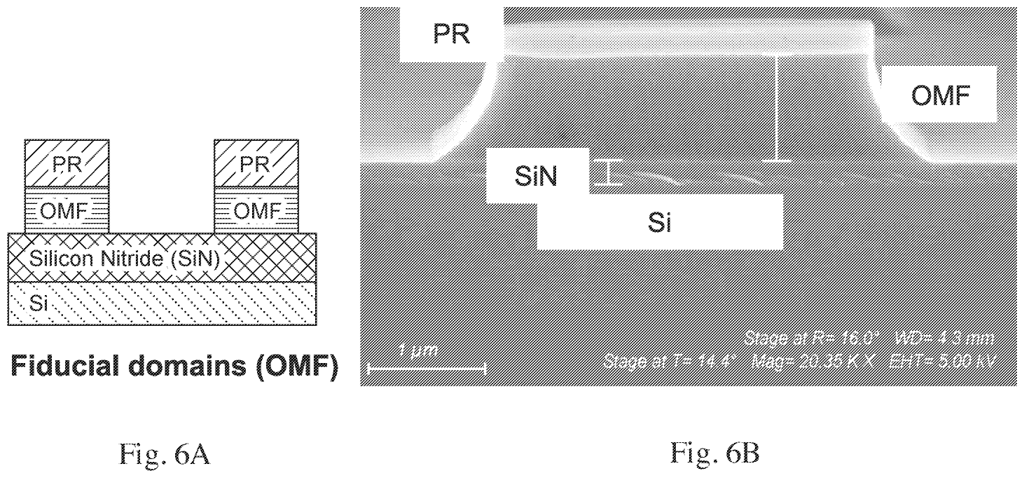

OMF material is then opened, in step 510, using for example, the following recipe in an ICP type etcher: 70 mT, 80 sccm CHF3, 8 sccm O2 at 150 W @13.56 MHz; for an etch rate of ER ˜700 Å/min. A time etched can be performed to fully open the OMF and minimize the etching into the silicon nitride layer. Thereafter, the PR is removed in step 512 (e.g., via EKC 830). FIG. 6A is a diagram of the FDs/OMF alongside a scanning Electron Microscopy (SEM) image thereof (FIG. 6B), created on a SiNx/Si wafer (following the noted steps above).

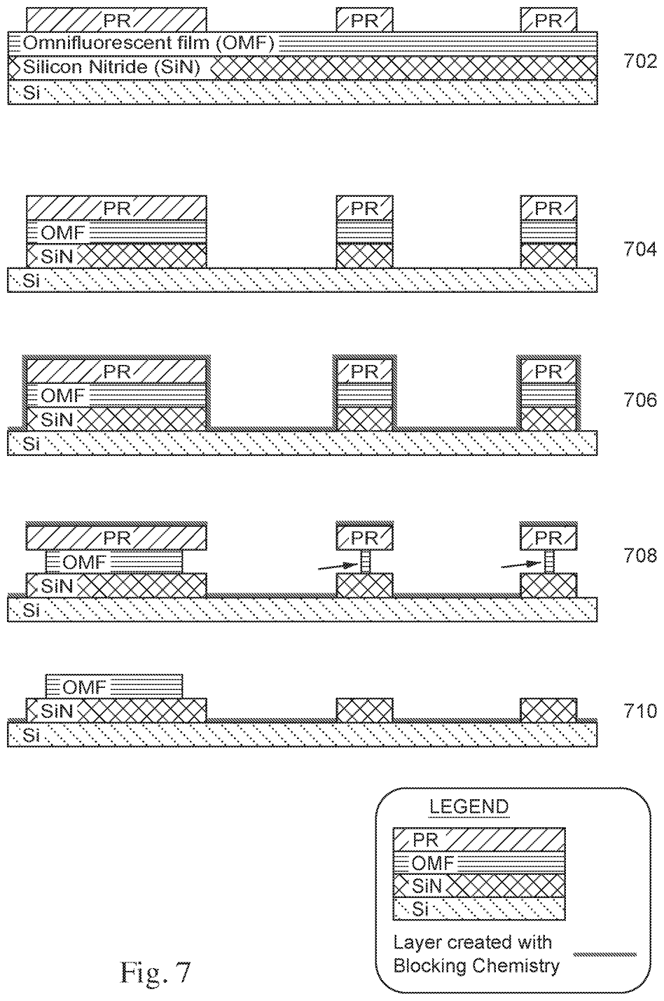

In another process, applicable for samples that need to incorporate both ordered arrays and fiducial domains (omni-fluorescent material), creates/establishes on a same chip both FDs and ordered arrays. FIG. 7 illustrates an overview of an example of such a process. The FDs comprise OMF material, and the ordered arrays are made (in some embodiments) of SiNx islands with the desired critical dimensions (CD). An advantage of this scheme is that it enables the creation of both features (FDs and ordered array) with only one photolithography pass (in some embodiments), making it a more cost-effective approach.

Accordingly, in this process, in step 702, a SiN/Si wafer is provided of preferably 100 nm SiNx thickness (in some embodiments, this represents a minimum thickness), an OMF film is applied, which is preferably between about 300-400 nm in thickness, the PR is then deposited (e.g., deep ultra-violet (DUV) type PR, of about 400 nm in thickness, according to some embodiments), and the PR is patterned with a desired pattern. The patterned features may include features of a large size, for example 100-500 nm, so as to define the FDs, as well as small features, for example 1-100 nm, that define the ordered arrays. In step 704, the OMF film and SiN film can be opened, and one of skill in the art will appreciate that, in some embodiments, there is no need for a selective process to be used as both layers require etching. For example, 70 millitesla (mT), 80 sccm CHF₃, 8 sccm O₂ at 150 Watts power @13.56 MHz, an etch rate (ER) of the omnifluorescent material (OMF) or about 700 Å/min, and ER of the silicon nitride layer (SiN) of about 600 Å/min for a low pressure chemical vapor deposition (LP CVD) SiN material. Here, the term sccm stands for standard cubic centimeters per minute, a flow measurement term indicating cm³/min in standard conditions for temperature and pressure of the fluid. It is well known that the etch rates depend on a reactor configuration and the film properties (i.e., method of preparation), and therefore, the above etch rates noted above serve as a guide. Timing is determined via characterization of the etch rates (which may be modified).

Next, in step 706 blocking chemistry can be performed which may include (in some embodiments):
(a) functionalization of the surface with APTMS to yield primary amines; and
(b) treatment of the primary amine surface with sulfo-NHS acetate.
   Such a process inhibits further downstream conjugation. In FIG. 7, the dark outline in step 706 represents the layer created by blocking chemistry.

Next, in step 708, an anisotropic etch of the OMF film may then be performed so as to laterally etch the OMF (e.g., see arrows in figure), thereby shrinking the footprint to approximately 300-400 nm in the FDs (larger features) and fully remove the smaller features, completely undercutting the PR and exposing the SiN ordered arrays. An exemplary isotropic wet etch can include using Buffered Oxide Etch (BOE) 10:1, which can achieve, in some embodiments, a lateral removal rate of the OMF features of about 100 nm per side per 15 seconds (in some embodiments). Thereafter, in step 710, removal of the PR is performed, and the wafer cleaned (e.g., using EKC 830 coupled with sample agitation).

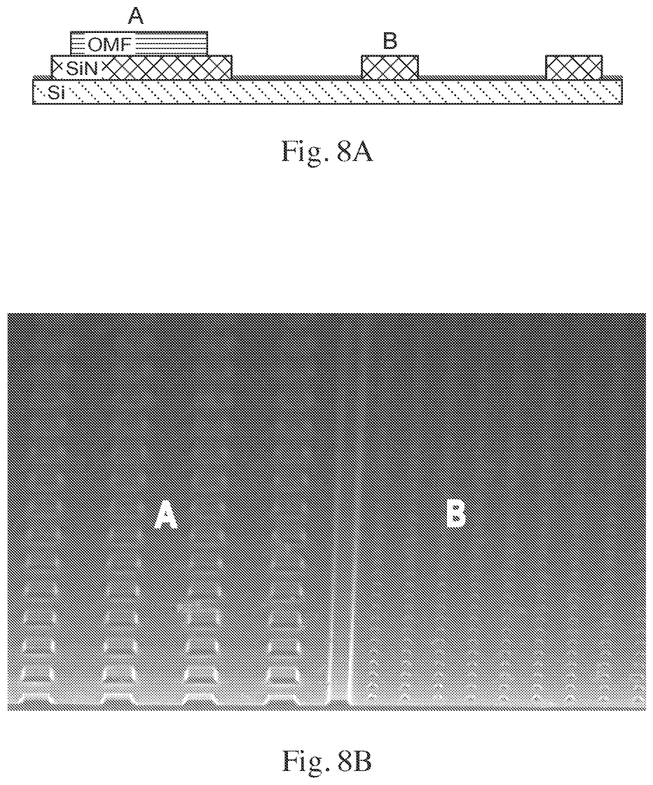

FIG. 8A illustrates a block diagram and FIG. 8B a Scanning Electron Microscopy (SEM) image of a wafer chip/substrate containing both OMF domain test structures and an ordered array region. The SEM shows the feasibility of producing these structures in one pass as described in the above noted scheme (i.e., performed in one pass).

One of skill in the art will appreciate that the above noted processes are but some methods for obtaining the desired structures on a wafer.

### Examples

The following portions of the disclosure set out non-limiting examples for a number of the steps of the manufacturing embodiments outlined above, according to some embodiments.

Omni-Fluorescent Material (OMF) Preparation
Spin on glass (SOG): in Lam we used Accuglass (made by Honeywell);
Dyes: Alexa Fluor 488 NHS, Alexa Fluor 532 NHS, Alexa Fluor 594 NHS, Alexa Fluor 647 NHS.

Protocol:
Each dye is dissolved in Accuglass per the desired concentration (overnight incubation);
Omni-fluorescent material is spin coated on chips of wafers or on full wafers (spin coated at 3000 rpm for 10 s, at room temperature; and
The coated wafer is cured at 80° C. for 2 hours on a hot plate

Determining Dye Concentration in the OMF
Each dye was dissolved in Accuglass in each concentration: 1, 10, and respectively 50 μM following the Protocol described above;
Each omni-fluorescent material created was spin coated on wafer chips at 3000 rpm for 10 second;
chips are heated at 80° C. for 2 hours on hot plate;
the fluorescence intensity of each of the samples was measured using a Leica Microscope;
image captured at 100 ms exposure time, fluorescence intensity is measured

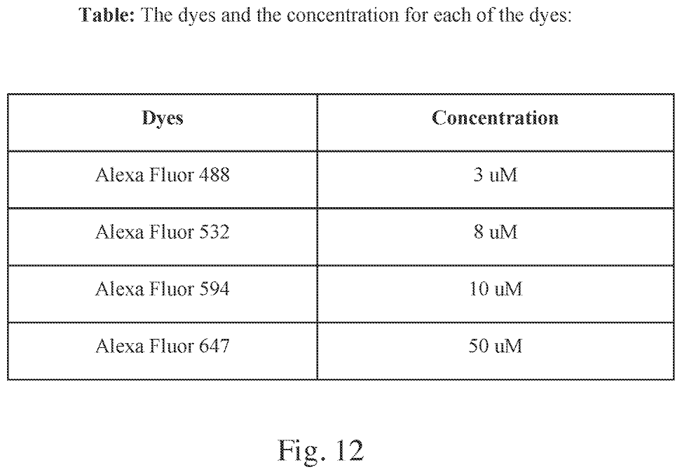

Fluorescence intensity increases with the dye concentration. Arbitrarily, we chose to work around a fluorescence intensity in the range of 20000±20% units. From the dependence of Fluorescence Intensity versus dye concentration, the desired concentrations were selected. The suggested concentrations are included in Table 1, as shown in FIG. 12.

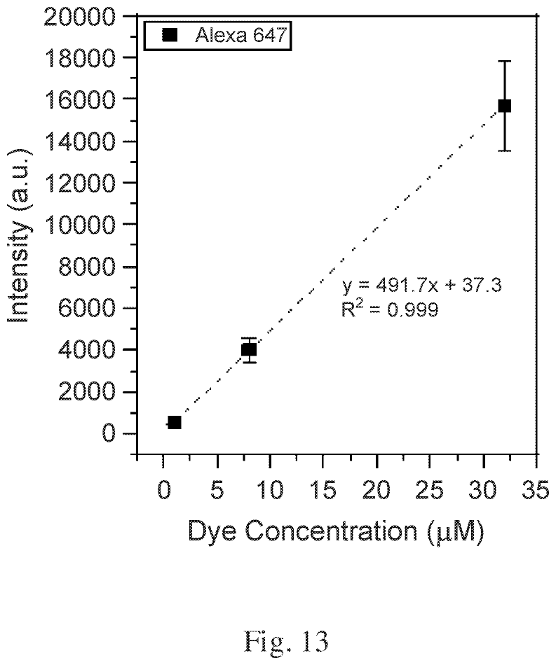

FIG. 13 illustrates a graph of Fluorescence Intensity versus Dye concentration. From this dependence, a concentration of 50 μM was extrapolated and chosen for the Alexa 647.

Procedure to Determine a Minimum Thickness of the OMF Layer

Material: Accuglass provided by Honeywell; spin recipe:
1. Dispense: 150 rpm for 3 seconds
2. Coat: xxxx rpm for 10 seconds (where xxxx=3000, 5000, 7000 rpm)
3. Bake: 80C for 2 hours on hotplate

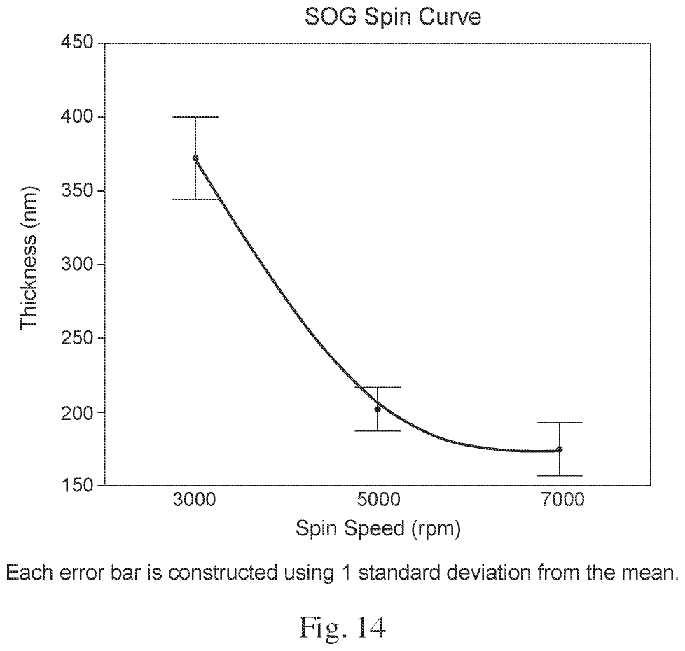

The thickness of the OMF layer varies with the spin speed as shown in the graph of FIG. 14. Increasing the spin speed further most likely will not significantly decrease the film thickness. The minimum OMF thickness to de deposited through spin coating process is around 175 nm. In most tests, coating speed was 3000 rpm for 10 seconds, which resulted in depositing around 350 nm of OMF.

Omnifluorescent (OMF) Material Patterning

Materials, Processing Steps and Tools:
1. Wafers either oxide/Si or SiNx/Si. Wafers of 150 mm.
2. Spin coat the OMF on the wafer:
   a. Omnifluorescent material supplied by Filmtronics, Inc.
   b. 6 mL spin coated onto 150 mm, 3000 rpm for 10 s, bake on hot plate 80C for 2 hours
3. PR coating: standard process done with Picotrack PR.
   a. HMDS prime
   b. PR coat: Dow UV210GS-0.6 photoresist 0.42 μm thick
   c. PR bake 120 C/30 min
4. PR patterning using ASML DUV Stepper Model 5500/300 (UC Berkeley).
Patterning mask can be either provided by UC Berkeley or manufactured by mask provider.
As mask provider we used HTA photomask (see, e.g., https://htaphotomask.com)

Pattern for the Fiducial Markers

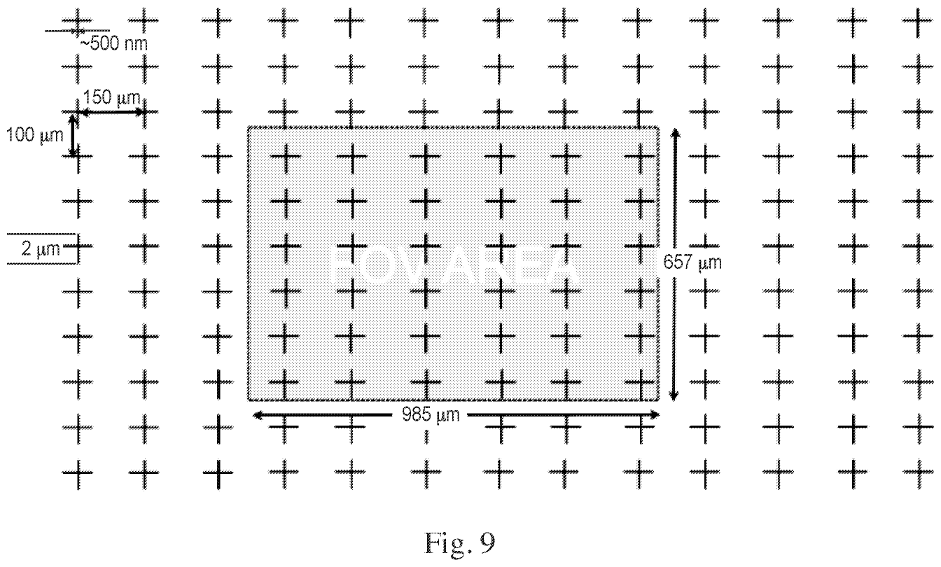

An example fiducial pattern is shown in FIG. 9. In the example shown in FIG. 9, the fiducial markers created are:
Crosses with 500 nm width;
Crosses with 300 nm width;
10 μm diameter circles with line width of 500 nm;
and
300 nm dots;
   Accordingly, a reticle/photomask was made to contains these features.

Four types of wafers were made, each type containing a type of fiducial markers:
Type 1: Crosses with 500 nm width;
Type 2: Crosses with 300 nm width;
Type 3: 10 μm diameter circles with line width of 500 nm;
and
Type 4: 300 nm dots.

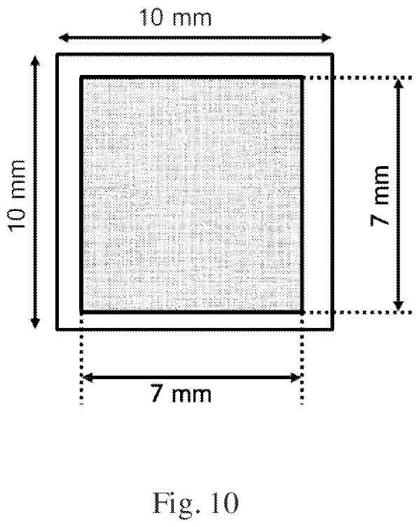

FIG. 10 illustrates an example die incorporating the fiducial markers, the die dimensions being (for example): a square of 10×10 mm, with an empty space of no features of 1.5 mm on each side. The fiducial pattern occupies the inside 7×7 mm square (filled portion).

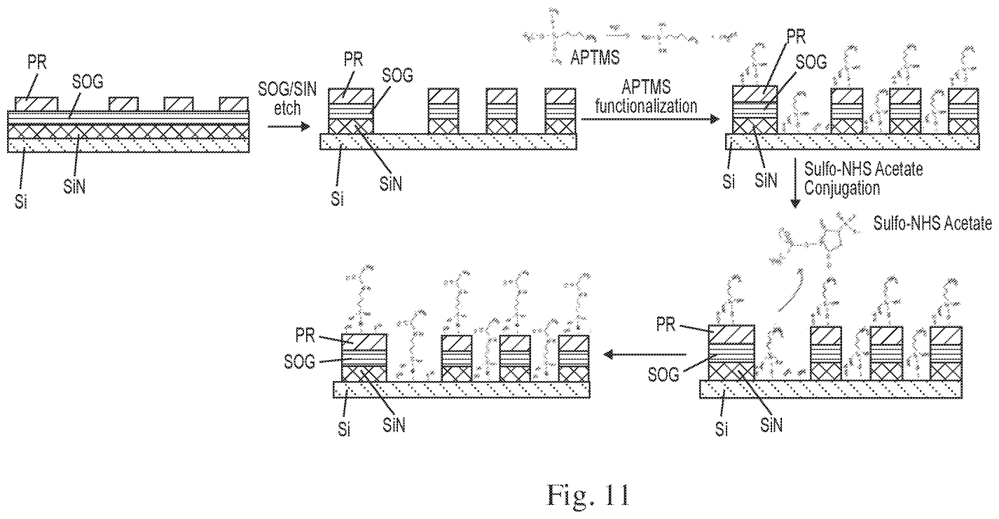

Blocking Chemistry
APTMS silanization
Sulfo-NHS-Acetate Conjugation
   The reactions taking place are described in the FIG. 11.

Silane functionalization can be prepared as follows:
Prepare 100 mL of 0.5% v/v 3-aminopropyl-trimethoxy-silane solution (APTMS) [0.5 mL stock in 100 mL Millipore H2O];
Place up to 6 Si repeat units per 100 mL APTMS solution in glass containers;
Repeat 1 min incubation followed by 10 sec sonication three times;
Wash with copious amounts of water and dry with Nitrogen gas; and
Incubate on hot plate at 110C for 10 mins;

Sulfo-NHS Acetate conjugation can be prepared as follows:
Weigh approximately 10 mg of NHS Acetate in 1.5 mL microcentrifuge tube and note down exact reagent weight (A mg);
Spin down the tube to make sure reagent powder settles to the bottom of the tube;
Generate NHS conjugation in 100 mM NaP pH8+Tween;
Add A*38.58 μL 100 mM NaP pH8+tween in NHS Acetate tube;
Spot 100 μL of NHS Acetate conjugation reagent per Si die and cover all dies with one large, plasma cleaned coverglass piece ensuring reagent spreads uniformly all over the silicon piece;
Incubate for 30 mins;
Rinse twice with 1X SSPE; and
Rinse twice with H2O and dry with nitrogen gas.

Photoresist (PR) Removal

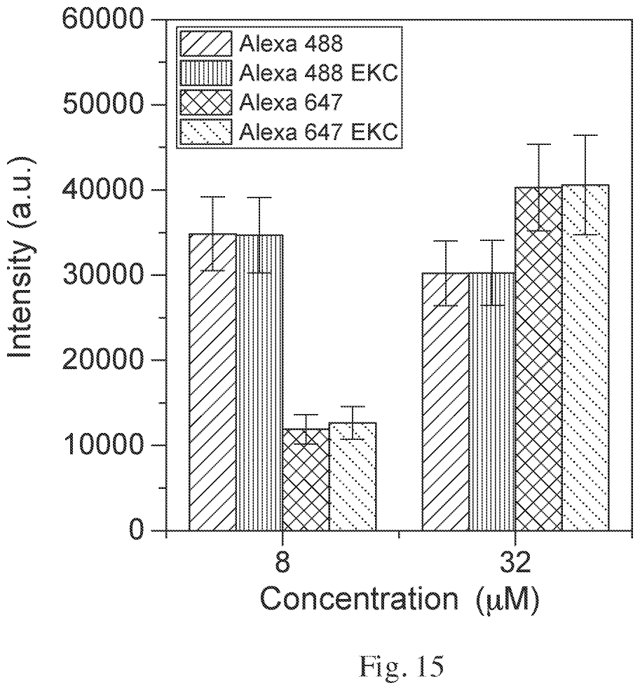

EKC 830™ was used to remove the photoresist. EKC 830™ is not affecting the properties of the OMF. FIG. 15 is a graph illustrating the fluorescence intensity of the OMF treated versus not treated with EKC 830™ is unchanged. The fluorescence intensity was measured using Leica microscope.

Procedure for PR removal (PR over the OMF layer), where the process is performed at 70C for 5 min sonication.

### Other Considerations

While various inventive embodiments have been described and illustrated herein, those of ordinary skill in the art will readily envision a variety of other means, functionality, steps, and/or structures (including, for example, software code) for performing one and/or another of the functionality disclosed, obtaining the results and/or one or more of the advantages described herein; each of such variations and/or modifications is deemed to be within the scope of the inventive embodiments described herein. More generally, those skilled in the art will readily appreciate that all parameters, and configurations described herein are meant to be exemplary and that the actual parameters, and configurations will depend upon the specific application or applications for which the inventive teachings is/are used. Those skilled in the art will recognize or be able to ascertain using no more than routine experimentation, many equivalents to the specific inventive embodiments described herein. It is therefore to be understood that the foregoing embodiments are presented by way of example only and that, within the scope of any claims supported by this disclosure and equivalents thereto, inventive embodiments may be practiced otherwise than as specifically described and claimed. Inventive embodiments of the present disclosure are also directed to each individual feature, system, apparatus, device, step, code, function, and method described herein. In addition, any combination of two or more such features, systems, apparatuses, devices, steps, code, functionalities, and methods, if such features, systems, apparatuses, devices, steps, code, functionalities, and methods are not mutually inconsistent, is included within the inventive scope of the present disclosure. Further embodiments may be patentable over prior art by specifically lacking one or more features/functionality/steps (i.e., claims directed to such embodiments may include one or more negative limitations to distinguish such claims from prior art).

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The terms “can” and “may” are used interchangeably in the present disclosure, and indicate that the referred to element, component, structure, function, functionality, objective, advantage, operation, step, process, apparatus, system, device, result, or clarification, has the ability to be used, included, or produced, or otherwise stand for the proposition indicated in the statement for which the term is used (or referred to), according to the respective embodiment(s) noted.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1-55. (canceled)

56. An array substrate manufacturing method for nucleic acid assays comprising: providing a substrate having at least one side comprising Silicon-Ox/Silicon; depositing an omni-fluorescent material (OMF) layer on the at least one side comprising the Silicon-Nx; depositing a photoresist layer (PRL) on the OMF layer; removing pattern portions of the PRL to establish a pattern in the PRL, wherein the removed portions expose corresponding portions of the OMF; removing the exposed portions of OMF to expose the Silicon-Nx/Silicon substrate; performing blocking chemistry; anisotropic etching of the OMF; and removing a remainder of the PRL thereby exposing the OMF domains.

57. A fiducial marker substrate preparation method comprising: dissolving a first dye in a spin-on-glass material (SOG) to a desired concentration to produce an omni-fluorescent material (OMF); spin-coating the OMF on a substrate at an RPM of between a predetermined amount for a predetermined amount of time at a first temperature; and curing the substrate at a second temperature for curing period.

58. The method of claim 57, wherein the RPMs comprise a range of between about 100 and about 4000.

59. The method of claim 57, wherein the RPMs are between about 100 and about 2000.

60. The method of claim 57, wherein the RPMs are between about 100 and about 1000.

61. The method of claim 57, wherein the RPMs are between about 100 and 500.

62. The method of claim 57, wherein the predetermined period of time is between 1 and 300 seconds.

63. The method of claim 57, wherein the predetermined period of time is between 1 and 200 seconds.

64. The method of claim 57, wherein the predetermined period of time is between 1 and 100 seconds.

65. The method of claim 57, wherein the predetermined period of time is between 100 and 300 seconds.

66. The method of claim 57, wherein the predetermined period of time is between 100 and 200 seconds.

67. The method of claim 57, wherein the predetermined period of time is between 30 and 150 seconds.

68. The method of claim 57, wherein the first temperature is room temperature.

69. The method of claim 57, wherein the second temperature is approximately 80 deg. C., and/or the curing period is approximately 2 hours.

70. The method of claim 57, further comprising repeating the preceding steps for each of a plurality of different dyes at the desired concentration.
